(19) United States
(12) Patent Application Publication
(10) Pub. No.: US 2013/0083738 A1
(43) Pub. Date: Apr. 4, 2013

(54) METHOD AND APPARATUS FOR MODIFYING RESOURCE ALLOCATION

(71) Applicants: Brian Martin, Surrey (GB); Keiichi Kubota, Surrey (GB); Chris Callender, Clackmannanshire (GB)

(72) Inventors: Brian Martin, Surrey (GB); Keiichi Kubota, Surrey (GB); Chris Callender, Clackmannanshire (GB)

(73) Assignee: RENESAS MOBILE CORPORATION, Toyko (JP)

(21) Appl. No.: 13/251,376

(22) Filed: Oct. 3, 2011

(51) Int. Cl. H04W 72/04

(52) U.S. Cl. 370/329

(57) ABSTRACT

A method, apparatus and computer program product are provided for causing a modification of a TTI E-DCH resource allocation in an instance in which a criterion for resource modification has been met. In this regard, a method is provided that includes determining whether a criteria for resource allocation modification has been satisfied. The method further includes causing a request for modification of a resource allocation to be transmitted in an instance in which the criterion for relocation allocation modification has been satisfied. The method also includes causing a modification to the resource allocation in an instance in which an indication of resource allocation modification is received.

### TECHNOLOGICAL FIELD

Embodiments of the present invention relate generally to communications technology and, more particularly, to modifications of resource allocation and resource utilization in wireless communications.

### BACKGROUND

A transmission time interval (TTI) is a parameter related to encapsulation of data from higher layers into frames for transmission on the radio link layer. TTI refers to the duration of a transmission on the radio link which may be used for hybrid automatic repeat request (HARM) decoding. A TTI resource allocation may be assigned to the mobile terminal based on signal conditions at a time a mobile terminal accesses a network resource. The initial TTI resource allocation may be determined based on a number of parameters, for example in an instance in which a mobile terminal's uplink power is limited and/or the mobile terminal is located at a the cell edge (e.g. edge of an access point coverage area), a 10 millisecond (ms) TTI may be adopted to improve coverage and decrease the inter-cell interference. By way of further example and in an instance in which the mobile terminal stays in the middle of cell or has a sufficient uplink power leftover, 2 ms TTI may be adopted. By way of further example, a 10 ms TTI may provide better coverage in while 2 ms TTI may provide higher data rate and lower delay.

However, assigning a TTI resource allocation at a time in which a mobile terminal accesses a network resource may cause various transmission errors as conditions and/or parameters of a mobile terminal's connection to a network resource change. For example, a mobile terminal may move within an access point coverage area and, as described above, such movement within an access point coverage area may result in errors based on a change of conditions. For example, in an instance in which a mobile terminal accesses an access point in the middle of the cell and is assigned a 2 ms TTI, but then moves to the cell edge where a 10 ms TTI would be advantageous, the mobile terminal may experience delays in data transfer and a radio link connection may be restarted if the mobile terminal cannot switch to a 10 ms TTI.

A number of methods have been proposed (e.g. 3rd Generation Partnership Project (3GPP) R2-113968, R2114075, R2-114111, and/or R2-114154 which are all hereby incorporated by reference) in an effort to provide some measure of TTI resource allocation and modification for a mobile terminal. However the proposals have generally suffered from various drawbacks including, for example, when splitting physical random access channel (PRACH) signature space, the already limited signature space may make it difficult to allocate enough resources in a highly loaded cell.

### BRIEF SUMMARY

A method, apparatus and computer program product are therefore provided according to an example embodiment in order to cause a modification of a current TTI common enhanced dedicated channel (E-DCH) resource allocation when a criteria for selection of an alternate TTI common E-DCH resource allocation is met (e.g. modification from a 2 ms TTI to a 10 ms TTI). In an embodiment, the method, apparatus and computer program product may cause a message to be transmitted to a network resource, such as an access point, indicating that a modification criterion for resource allocation has been met. In response to the message, an order, such as a high-speed shared control channel (HS-SCCH) order, may be received by the mobile terminal that causes the modification of the current TTI common E-DCH resource allocation. Alternatively or additionally and in some embodiments, resource allocation rules may be defined by an HS-SCCH order and/or may be preconfigured and stored in a mobile devices memory, such that the resource allocation rules are configured to cause an E-DCH resource to be chosen based on the modified TTI.

In an embodiment a method includes determining whether a criteria for resource allocation modification has been satisfied. The method further includes causing a request for modification of a resource allocation to be transmitted in an instance in which the criterion for relocation allocation modification has been satisfied. The method also includes causing a modification to the resource allocation in an instance in which an indication of resource allocation modification is received.

In another embodiment, an apparatus comprising a processor and a memory including software, with the memory and the software configured to, with the processor, cause the apparatus at least to determine whether a criteria for resource allocation modification has been satisfied. The apparatus is further caused to cause a request for modification of a resource allocation to be transmitted in an instance in which the criterion for relocation allocation modification has been satisfied. The apparatus is further caused to cause a modification to the resource allocation in an instance in which an indication of resource allocation modification is received.

In a further embodiment, a computer program product is provided that includes at least one computer readable non-transitory memory having program code stored thereon with the program code which when executed by an apparatus causes the apparatus at least to determine whether a criteria for resource allocation modification has been satisfied. A computer program product also includes program code that is further configured to cause a request for modification of a resource allocation to be transmitted in an instance in which the criterion for relocation allocation modification has been satisfied. A computer program product also includes program code that is further configured to cause a modification to the resource allocation in an instance in which an indication of resource allocation modification is received.

In yet another embodiment, an apparatus is provided that includes means for determining whether a criteria for resource allocation modification has been satisfied. An apparatus further comprises means for causing a request for modification of a resource allocation to be transmitted in an instance in which the criterion for relocation allocation modification has been satisfied. An apparatus further comprises means for causing a modification to the resource allocation in an instance in which an indication of resource allocation modification is received.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of a system having a mobile terminal that may experience resource allocation modification and that may benefit from an embodiment of the present invention;

FIG. 2 is a block diagram of an apparatus that may be embodied by a mobile terminal in accordance with one embodiment of the present invention;

FIG. 3 is a flow chart illustrating operations performed in accordance with one embodiment of the present invention; and

FIG. 4 illustrates a signal flow diagram illustrating operations performed in accordance with another embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product of an example embodiment of the present invention are configured to determine instances in which a mobile terminal may cause a modification of the common E-DCH resource TTI allocation based on the satisfaction of a resource allocation modification criterion. In accordance with an example embodiment, a mobile terminal may be configured to determine whether a criterion for modification of a TTI resource allocation has been satisfied. Such criterion includes but is not limited to current radio conditions, buffer occupancy and/or a channel quality indication (CQI). In an instance in which the criterion for modification of a TTI resource allocation has been satisfied, a request may be transmitted to a network resource, such as an access point, that requests a reallocation and/or modification of the TTI. In an embodiment, the mobile terminal may then receive an order, such as an HS-SCCH order, that causes the modification of the TTI.

In example embodiments, resource allocation rules may be pre-configured to optionally adjust and/or select a new common E-DCH resource based on the stored set of resources and the modified TTI resource allocation. For example, a resource offset and/or a scrambling code may be used. Alternatively or additionally the mobile terminal may be configured to receive two resources (e.g. one 2 ms TTI resource and one 10 ms TTI resource) thereby allowing the mobile terminal to, for example, switch between the TTI resources based on the systems and methods described herein.

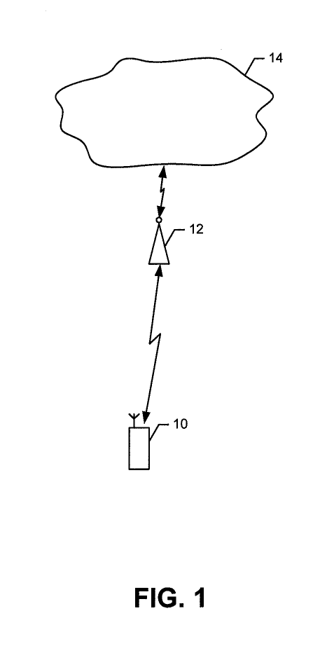

Although the method, apparatus and computer program product may be implemented in a variety of different systems, one example of such a system is shown in FIG. 1, which includes a first communication device (e.g., mobile terminal 10) that is capable of communication via an access point 12, such as a base station, a Node B, an evolved Node B (eNB), serving cell or other access point, with a network 14 (e.g., a core network). While the network may be configured in accordance with Long Term Evolution (LTE) or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more cells, including access point 12, each of which may serve a respective coverage area. The serving cell and the neighbor cells could be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

A communication device, such as the mobile terminal 10 (also known as user equipment (UE)), may be in communication with other communication devices or other devices via the access point 12 and, in turn, the network 14. In some cases, the communication device may include an antenna for transmitting signals to and for receiving signals from a serving cell.

When referred to herein, a serving cell includes, but is not limited to a primary serving cell (PCell) and other serving cells such as secondary serving cells (SCell) that may be operating on an access point, such as access point 12. A candidate cell, target cell, neighbor cell and/or the like may also be used herein, and that includes a cell that is not currently a serving cell, but may become a serving cell in the future. A PCell, which may be embodied by an access point, generally includes, but is not limited to, a cell that is configured to perform initial establishment procedures, security procedures, system information (SI) acquisition and change monitoring procedures on the broadcast channel (BCCH) or data channel (PDCCH), and paging. The SCell, which may be embodied by a remote radio head (RRH) and is configured to provide additional radio resources to the PCell. In an embodiment, a “primary band” is the band that is indicated by the serving cell as the band of a serving carrier frequency. The secondary band is the band that is indicated by the serving cell as an additional band (e.g. in addition to primary band), that allows a mobile terminal radio frequency that is supported by the secondary band to also camp on the cell.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal 10 may include one or more processors that may define processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 14.

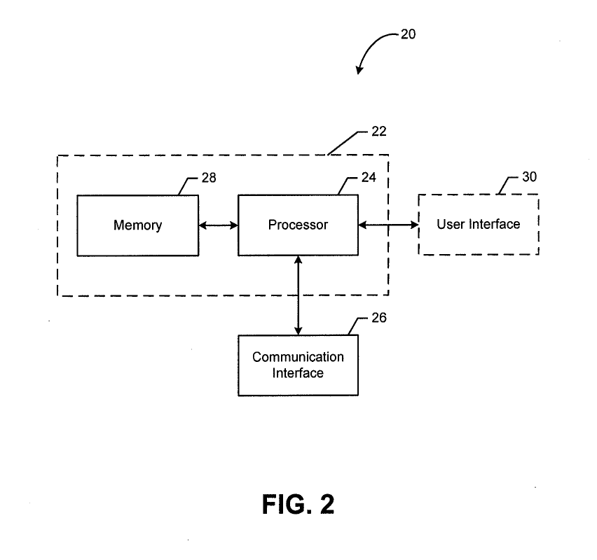

In one embodiment, for example, the mobile terminal 10 and/or the access point 12 may be embodied as or otherwise include an apparatus 20 as generically represented by the block diagram of FIG. 2. While the apparatus 20 may be employed, for example, by a mobile terminal 10 or an access point 12, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as a access point 12, the—apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the access point 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

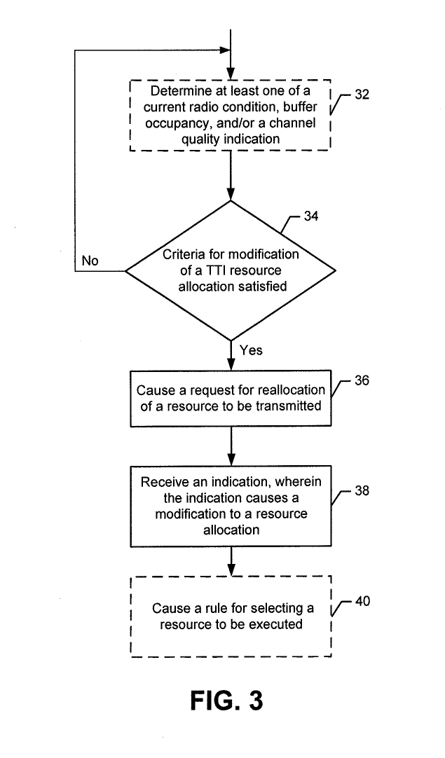

FIG. 3 is a flowchart illustrating the operations performed by a method, apparatus and computer program product, such as apparatus 20 of FIG. 2, from the perspective of a mobile terminal 10 in accordance with one embodiment of the present invention is illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 3, when executed, convert a computer or processing circuitry into a particular machine configured to perform an example embodiment of the present invention. Accordingly, the operations of FIG. 3 define an algorithm for configuring a computer or processing circuitry 22, e.g., processor, to perform an example embodiment. In some cases, a general purpose computer may be provided with an instance of the processor which performs the algorithm of FIG. 3 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (an example of which is shown in dashed lines in FIG. 3). It should be appreciated that each of the modifications, optional additions or amplifications below may be included with the operations above either alone or in combination with any others among the features described herein.

Referring now to FIG. 3, the operations of a method, apparatus and computer program product are configured to provide an indication from a mobile terminal 10 to an access point 12 or other network element in an instance in which a criterion for a modification of a resource allocation is met. In response the access point 12 or other network element may cause a TTI resource allocation to be modified. As shown in operation 32, the apparatus 20 may include means, such as the processing circuitry 22, the processor 24 or the like, for determining at least one of a plurality of resource modification parameters, wherein TTI resource modification parameters may include but are not limited to current radio conditions, buffer occupancy threshold, and/or CQI. While several parameters are described below for purposes of illustration, additional or different parameters may be determined in other embodiments. For example, the apparatus may include means, such as the processing circuitry, the processor or the like, for determining the transmission power for signals transmitted by the mobile terminal via an uplink channel. In one embodiment, the apparatus, such as the processor, may determine the transmission power of the signals transmitted via the uplink dedicated physical control channel (DPCCH) to the serving cell. In an instance in which the transmission power for signals transmitted via an uplink channel, such as the uplink DPCCH, is relatively high, the mobile terminal may be located relatively far from the serving cell and/or the mobile terminal may be suffering from uplink interference from other mobile terminals served by neighbor cells. In either instance, a relatively high transmission power for signals transmitted via an uplink channel of the mobile terminal may create the need for a change in TTI resource allocation (e.g., from a 2 ms TTI to a 10 ms TTI).

Additionally or alternatively, the apparatus 20 may also include means, such as the processing circuitry 22, the processor 24 or the like, for determining other parameters, such as radio conditions, associated with the operation of the mobile terminal 10 that may result in a modification of a resource allocation. Example radio conditions include, but are not limited to interference, cell coverage, uplink power head room, received signal power and/or the like. Additionally or alternatively, the apparatus 20 may also include means, such as the processing circuitry 22, the processor 24 or the like, for determining a current data transmission buffer occupancy. For example, in an instance in which the current data transmission buffer has only a small amount of data then a modification of a resource allocation may not be necessary because, for example, it may be more efficient to complete the transmission of the data in the data transmission buffer using the existing resource. For example, in an instance in which the buffer occupancy is above a threshold amount of data and another criteria of operation 32 is met, then a modification of a resource allocation may be requested.

Based upon at least one of the resource modification parameters determined with respect to operation 32, such as the radio conditions, the buffer occupancy, the CQI and/or the like, the apparatus 20, such as the processor 24, may determine if the criteria for modification of TTI resource has been satisfied. See operation 34 of FIG. 3. For example, the apparatus, such as the processor, may be configured to compare the radio conditions, buffer occupancy and/or a CQI with a threshold. The threshold may be pre-defined and stored by memory 28 of the apparatus. Alternatively, a network element, such as the access point 12, a radio network controller or the like, may notify the mobile terminal 10 of the respective thresholds. In one embodiment, the parameters need not just satisfy respective thresholds at one instant in time in order to be considered to be indicative of a criterion for modification of a TTI resource, but in alternative embodiments may need to satisfy the respective thresholds for predetermined periods of time (e.g. a minimum amount of time before threshold is considered to be met).

While the apparatus 20, such as the processor 24, may simply continue to monitor the various parameters for an instance in which the parameters satisfy the respective thresholds, in an instance in which a parameter does satisfy the respective threshold the apparatus 20 may include means, such as the processing circuitry 22, the processor 24, the communication interface 26 or the like, for causing a request for reallocation of a resource to be transmitted. See operation 36 of FIG. 3. The request for reallocation of resource may be communicated using signaling, such as layer 1 and/or layer 2 signaling, to indicate that a criteria for modifying resource allocation has been met. Alternatively or additionally, the apparatus 20 may include means, such as the processing circuitry 22, the processor 24, the communication interface 26 or the like, for causing a request for reallocation to be transmitted using a value of the CQI, an average value derived from CQI or by using medium access control (MAC) signaling using scheduling information (SI) or a special layer 2 protocol data unit (PDU). The mobile terminal 10 may provide the request for reallocation of resource to the access point 12, a radio network controller or other network element.

Upon receipt of the request for reallocation of resource, the network element, such as access point 12 may determine whether a modification of a resource allocation is necessary. In some embodiments, the network device may determine that modification of a resource allocation is not necessary even though one or more parameters have satisfied a threshold. For example, network traffic, uplink interference, resource shortages, service prioritization and/or the like may cause the network device to determine not to modify a resource allocation. In an instance in which the network resource, such as the access point 12 determines that the network resource should be modified, the network element may cause an HS-SCCH order to be transmitted. An HS-SCCH order may be configured to indicate a particular TTI resource to be used and/or may indicate a change of a TTI resource allocation. Additionally or alternatively, the network element may cause the modification of a TTI based on a CQI received from the mobile terminal without receiving a request for reallocation from the mobile terminal.

As is shown in operation 38, the apparatus 20 may include means, such as the processing circuitry 22, the processor 24, the communication interface 26 or the like, for receiving an indication from network resource, such as an access point, wherein the indication causes a modification to a resource allocation. For example, the apparatus 20 may receive an order, such as HS-SCCH order, that indicates a TTI to be used (e.g., 2 ms TTI, 10 ms TTI, and/or the like). In response to the received order, the apparatus 20, such as the mobile terminal 20, the processor 24, the communication interface 26 or the like may then cause a resource, such as an E-DCH resource to be chosen based on the indicated TTI. See operation 40 of FIG. 3. The resource, such as the E-DCH resource, may be chosen by the apparatus 20, such as by the processor 10 from a plurality of stored resources that may be stored in the memory 28. A particular E-DCH resource may also be preconfigured by the network device, such as by the access point 12, prior to the transmission of the order and subsequently received by the mobile terminal with the order.

Alternatively or additionally, the apparatus 20 may also include means, such as the processing circuitry 22, the processor 24 or the like, for causing a rule for selecting a resource, such as an E-DCH resource, to be executed. See operation 40 of FIG. 3. In some embodiments, even though an order, such as the HS-SCCH order, may be received, an apparatus 20, such as for example the mobile terminal 10 may not have received instructions for resource allocation. Thus, as described herein, rules for E-DCH resource allocation may be preconfigured and/or received from a network resource, such as from access point 12. For example, a rule may use an index to select a particular resource out of a block of resources. For example, if example resources 1-16 are 10 ms TTI resources and example resources 17-32 are 2 ms TTI resources such resource blocks would define an index of 16 (e.g., resources 1 and 17, 2 and 18, etc.) thus allowing the mobile terminal 10 to easily determine a resource allocation in an instance in which a TTI is modified. An offset may be determined by the mobile terminal and/or the mobile terminal may receive an indication of the index from a network resource. In either example, once an offset is known the mobile terminal and/or the network device may add/subtract the index to the current resource to determine the current resource allocation. By way of further example, if an apparatus 20, such as mobile terminal 10 is currently using resource 3, then in an instance in which a TTI is modified, the apparatus 20, such as the mobile terminal 10, would then be configured to operate on resource 19. Advantageously, for example, such a known index would enable a mobile terminal and a network device to know, for example, which E-DCH resource was to be used without further signaling or an allocation action of E-DCH resources.

Alternatively or additionally, the apparatus 20 may also include means, such as the processing circuitry 22, the processor 24 or the like, for determining a scrambling code used in the order, such as the HS-SCCH order. Once a scrambling code is determined, the apparatus 20, such as the mobile terminal 10 may use the same resource index as the determined scrambling code in instances in which a network resource, such as the access point 12, has configured TTI resources, such as 10 ms and/or 2 ms TTI, in the same index of different scrambling codes. In yet a further embodiment, the network resource, such as the access point 12, may be configured to provide the apparatus 20, such as the mobile terminal 10, with one 2 ms TTI resource and one 10 ms TTI resource which may advantageously be switched by the mobile terminal 10.

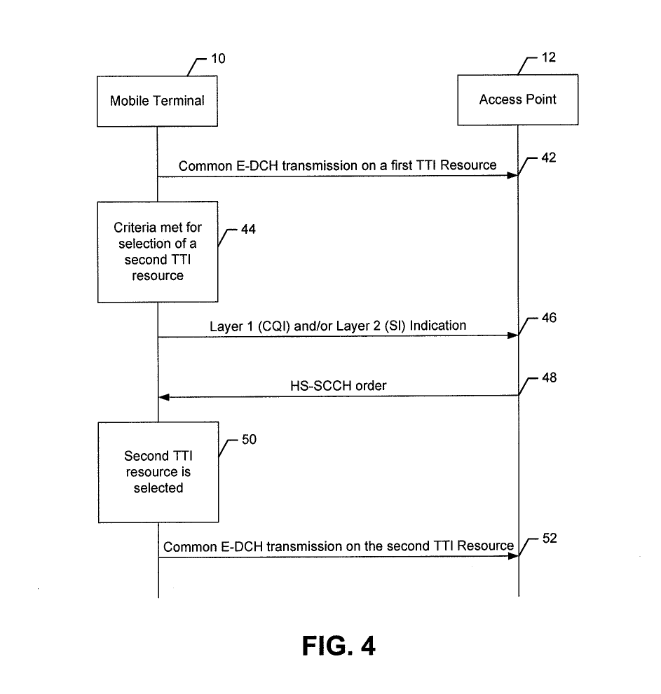

FIG. 4 illustrates an example signal flow diagram illustrating operations performed in accordance with an embodiment of the present invention. In an embodiment, a mobile terminal 10, may be communicating with an access point 12 using common E-DCH transmission on a first TTI resource, for example a 2 ms TTI resource. See signal 42 of FIG. 4. In an instance in which a criteria is met for selection of a second TTI resource, as is shown with reference to block 44, a layer 1 (CQI) and/or a layer 2 (SI) indication may be transmitted by mobile terminal 10 and received by access point 12. See signal 46 of FIG. 4. In response to the layer 1 and/or layer 2 indication, an HS-SCCH order may be generated and transmitted from the access point 12 to the mobile terminal 10. The HS-SCCH order is configured to cause a second TTI resource to be selected as is shown in block 50 of FIG. 4. After the second TTI resource is selected, the mobile terminal 10 may communication with access point 12 using a common E-DCH transmission on the second TTI resource. See signal 52 of FIG. 4.

Advantageously, for example, the systems and methods as described herein may be configured to enable the switching between TTI resources during a common E-DCH resource allocation. Advantageously, the example systems and methods as described herein may improve reliability of a 2 ms and/or a 10 ms TTI by allowing a mobile terminal to switch to the opposite TTI (10 ms and/or 2 ms respectively) if conditions allow.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining whether a criteria for resource allocation modification has been satisfied;
causing a request for modification of a resource allocation to be transmitted in an instance in which the criteria for relocation allocation modification has been satisfied; and
causing a modification to the resource allocation in an instance in which an indication of resource allocation modification is received.

2. A method of claim 1, wherein the resource allocation comprises a transmission time interval (TTI) resource allocation.

3. A method of claim 1 further comprises determining at least one of a plurality of resource modification parameters, wherein resource modification parameters include at least one of radio conditions, buffer occupancy, or channel quality indication.

4. A method of claim 3, wherein determining whether the criteria for resource allocation has been satisfied further comprises determining whether a radio condition satisfies a threshold value, wherein in an instance in which the radio condition threshold value is satisfied the criteria for resource allocation has been satisfied.

5. A method of claim 4, wherein a radio condition includes at least one of path loss, interference, cell coverage, uplink power headroom, uplink power or received signal code power.

6. A method of claim 3, wherein determining whether the criteria for resource allocation has been satisfied further comprises determining whether a buffer occupancy threshold has been satisfied, wherein in an instance in which the buffer occupancy threshold has been satisfied, then the criteria for resource allocation has been satisfied.

7. A method of claim 3, wherein determining whether the criteria for resource allocation has been satisfied further comprises determining whether a value derived from a channel quality indication (CQI) value exceeds a threshold value, wherein in an instance in which the derived CQI value exceeds a threshold, then the criteria for resource allocation has been satisfied.

8. A method of claim 1, wherein causing the request for reallocation of the resource to be transmitted further comprises generating a request using at least one of a value of channel quality indication (CQI), scheduling information (SI) or a layer 2 control protocol data unit (PDU).

9. A method of claim 1, further comprises receiving a high-speed shared control channel (HS-SCCH) order to switch common enhanced dedicated channel (E-DCH) transmission time interval (TTI).

10. A method of claim 9, wherein receiving the HS-SCCH order further comprises determining a common E-DCH resource for the modified resource allocation based on at least one of a resource index or a received scrambling code.

11. An apparatus comprising:
a processor and
a memory including software, the memory and the software configured to, with the processor, cause the apparatus to at least:
determine whether a criteria for resource allocation modification has been satisfied;
cause a request for modification of a resource allocation to be transmitted in an instance in which the criteria for relocation allocation modification has been satisfied; and
cause a modification to the resource allocation in an instance in which an indication of resource allocation modification is received.

12. An apparatus of claim 11, wherein the resource allocation comprises a transmission time interval (TTI) resource allocation.

13. An apparatus of claim 11, wherein the at least one memory including the computer program code is further configured to, with the at least one processor, cause the apparatus to determine at least one of a plurality of resource modification parameters, wherein resource modification parameters include at least one of radio conditions, buffer occupancy, or channel quality indication.

14. An apparatus of claim 13, wherein the at least one memory including the computer program code is further configured to, with the at least one processor, cause the apparatus to determine whether a radio condition satisfies a threshold value, wherein in an instance in which the radio condition threshold value is satisfied the criteria for resource allocation has been satisfied.

15. An apparatus of claim 14, wherein a radio condition includes at least one of path loss, interference, cell coverage, uplink power headroom, uplink power or received signal code power.

16. An apparatus of claim 13, wherein the at least one memory including the computer program code is further configured to, with the at least one processor, cause the apparatus to determine whether a buffer occupancy threshold has been satisfied, wherein in an instance in which the buffer occupancy threshold has been satisfied, then the criteria for resource allocation has been satisfied.

17. An apparatus of claim 13, wherein the at least one memory including the computer program code is further configured to, with the at least one processor, cause the apparatus to determine whether the criteria for resource allocation has been satisfied further comprises determining whether a value derived from a channel quality indication (CQI) value exceeds a threshold value, wherein in an instance in which the derived CQI value exceeds a threshold, then the criteria for resource allocation has been satisfied.

18. An apparatus of claim 11, wherein the at least one memory including the computer program code is further configured to, with the at least one processor, cause the apparatus to generate a request using at least one of a value of channel quality indication (CQI), scheduling information (SI) or a layer 2 control protocol data unit (PDU).

19. An apparatus of claim 11, wherein the at least one memory including the computer program code is further configured to, with the at least one processor, cause the apparatus to receive a high-speed shared control channel (HS-SCCH) order to switch common enhanced dedicated channel (E-DCH) transmission time interval (TTI).

20. An apparatus of claim 19, wherein the at least one memory including the computer program code is further configured to, with the at least one processor, cause the apparatus to determine a common E-DCH resource for the modified resource allocation based on at least one of a resource index or a received scrambling code.
